(19) United States
(12) Patent Application Publication
(10) Pub. No.: US 2026/0147889 A1
(43) Pub. Date: May 28, 2026

(54) EXECUTABLE PARSER AND FEATURE EXTRACTOR

(71) Applicant: CrowdStrike, Inc., Sunnyvale, CA (US)

(72) Inventors: Mihai Maganu, Stuttgart (DE); Claudian Mihai Chirita, Bucharest (RO); Ioana-Sabina Stoian, Iasi (RO); Filip Munteanu, Bucharest (RO)

(21) Appl. No.: 18/960,482

(22) Filed: Nov. 26, 2024

(51) Int. Cl. G06F 21/56; G06F 9/445; G06F 21/57; G06F 40/205

(52) U.S. Cl. CPC G06F 21/563; G06F 9/44521; G06F 21/577; G06F 40/205; G06F 2221/033

(57) ABSTRACT

The present disclosure provides techniques for executable parsing and feature extraction. A processing device identifies an operating system (OS) associated with an executable file and a version of a programming language associated with the executable file based on contents of the executable file. The processing device parses the executable file based on the OS associated with the executable file and the version of the programming language. The processing device extracts a set of features based on the parsed executable file. The processing device provides, as an input to an artificial intelligence (AI) model, the set of features, where the AI model is trained to classify executable files. The processing device obtains, as an output of the AI model, a classification of the executable file based on the input and learned parameters of the AI model.

### TECHNICAL FIELD

Aspects of the present disclosure relate to cybersecurity, and more particularly, to an executable parser and a feature extractor.

### BACKGROUND

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing mathematical and computational frameworks used to extract patterns and insights from data. Large language models (LLMs), a category within machine learning models, are trained on vast amounts of text data to capture the nuances of language and context. By combining advanced machine learning techniques with enormous datasets, large language models harness data-driven approaches to achieve highly sophisticated language understanding and generation capabilities. AI models include machine learning models, large language models, and other types of models that are based on neural networks, genetic algorithms, expert systems, Bayesian networks, reinforcement learning, decision trees, or combination thereof.

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a system for executable parsing and feature extraction in accordance with some aspects of the present disclosure.

FIG. 2 is a flow diagram of a method of executable parsing and feature extraction in accordance with some aspects of the present disclosure.

FIG. 3 is a flow diagram of a method of executable parsing and feature extraction in accordance with some aspects of the present disclosure.

FIG. 4 is a block diagram that illustrates an example of a system for executable parsing and feature extraction in accordance with some aspects of the present disclosure.

FIG. 5 illustrates a diagrammatic representation of a machine in an example form of a computer system that may perform one or more of the operations described herein in accordance with some aspects of the present disclosure.

### DETAILED DESCRIPTION

An AI model may be used to detect a cybersecurity threat that occurs with respect to an executable file. For example, a computing system may train an AI model based on executable files known to be associated with cybersecurity threats and executable files known not to be associated with cyber security threats. At inference, the computing system (or another computing system) may obtain an executable file. The executable file may or may not be associated with a cybersecurity threat. The computing system may provide, as input to the AI model, the executable file, portions of the executable file, and/or features derived from the executable file. The AI model may output, based on the input and learned parameters of the AI model, an indication as to whether the executable file is or is associated with a cybersecurity threat.

Some executable files may include characteristics that reduce performance of an AI model in classifying an executable file as malicious (i.e., as a cybersecurity threat) or non-malicious. For example, an executable file may include garbage collector related functionality which may increase a size of the executable file. Furthermore, the executable file may be statically linked, that is, the executable file may embed a large runtime environment that does not rely on external dependencies. Additionally, the executable file may include a relatively large amount of strings. The aforementioned characteristics may cause a size of the executable file to be relatively large in comparison to executable files that do not include or are not associated with the aforementioned characteristics. Moreover, the aforementioned characteristics may cause the executable file to include a relatively large amount of noise compared to executable files that do not include or are not associated with the aforementioned characteristics. Training an AI model based on an executable file that is relatively large and/or relatively noisy may impact performance of the AI model, that is, the AI model may not accurately classify an executable file as malicious or non-malicious. Furthermore, processing an executable file that is relatively large and/or relatively noisy at inference may consume a relatively large amount of computational resources (e.g., processor clock cycles), which may increase an amount of time for the AI model to classify the executable file as malicious or non-malicious.

The present disclosure addresses the above-noted and other deficiencies by using a processing device for executable parsing and feature extraction. The processing device may identify an executable file (e.g., identify an operating system (OS) associated with the executable file and a version of a programming language associated with the executable file. In an example, the executable file may be associated with the Go® programming language. In an example, the executable file may be relatively large, may include garbage collector functionality, and/or may be relatively noisy. The processing device may parse internal structures of the executable file. The processing device may extract relevant features from the internal structures. The processing device (or another processing device) may use the extracted relevant features for training an AI model (e.g., an ML model) and/or at inference.

In an example, a processing device identifies an OS associated with an executable file and a version of a programming language associated with the executable file based on contents of the executable file. The processing device parses the executable file based on the OS associated with the executable file and the version of the programming language. The processing device extracts a set of features based on the parsed executable file. In some aspects, the parsing and/or the extraction of the set of features may be performed by a first parser written in a first programming language that is different from a second parser (e.g., a debugging parser) associated with a toolchain of a second programming language associated with the executable file in order to provide for increased performance. For instance, the first parser may have a first size that is less than a second size of the second parser. When the processing device executes the first parser, the first parser may more rapidly parse and extract the set of features compared to the second parser, which may reduce processor clock cycles used to parse and extract the set of features. The processing device provides, as an input to an artificial intelligence (AI) model, the set of features, where the AI model is trained to classify executable files. The processing device obtains, as an output of the AI model, a classification of the executable file based on the input and learned parameters of the AI model.

As discussed herein, the present disclosure provides an approach that improves the operation of a computer system by improving a training process and/or an inference process of an AI model using a set of features extracted from an executable file based on an OS associated with the executable file and a version of a programming language associated with the executable file. In addition, the present disclosure provides an improvement to the technological field of cybersecurity by training an AI model to more accurately detect a cybersecurity threat from an executable file, such as a Go® executable file. The trained AI model may more accurately detect a cybersecurity threat from an executable at inference as well.

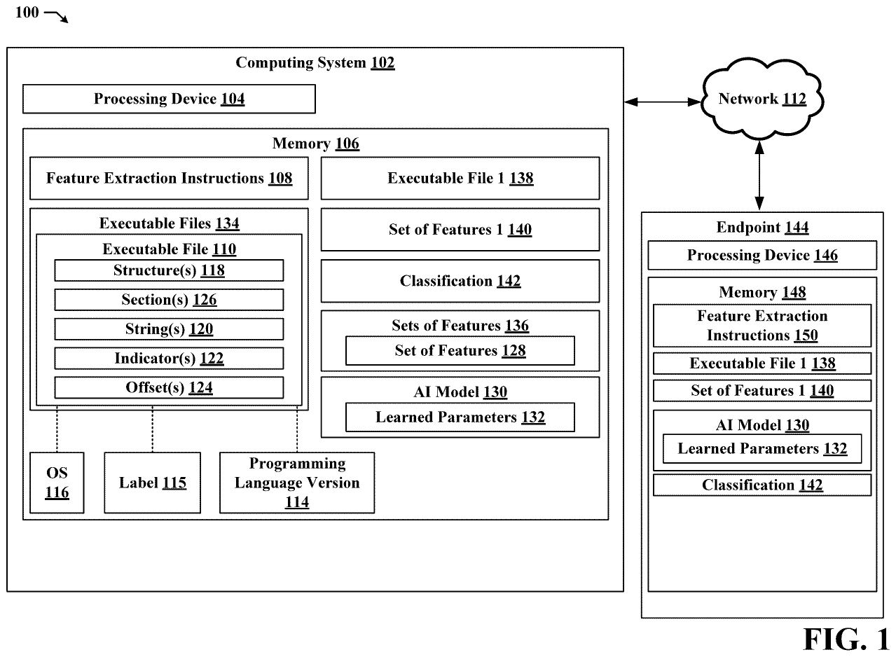

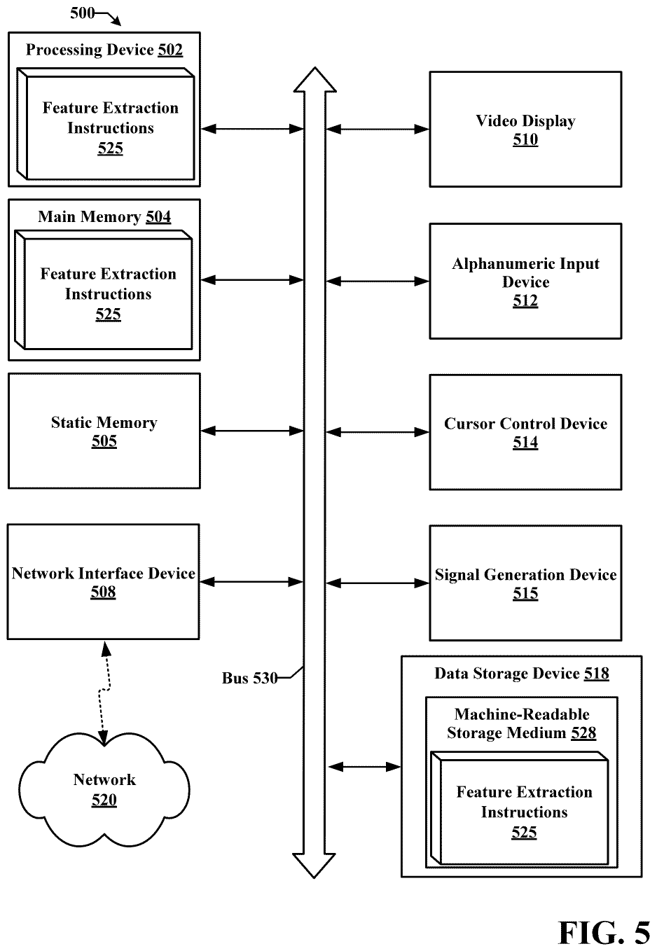

FIG. 1 is a block diagram 100 that illustrates an example of a system for executable parsing and feature extraction in accordance with some aspects of the present disclosure. The system includes a computing system 102. The computing system 102 may include a processing device 104 (e.g., a central processing unit (CPU), a graphics processing unit (GPU), etc.) and memory 106. In an example, the computing system 102 may be or include a server, a cloud server, a desktop computing device, a laptop computing device, etc. In some aspects, the computing system 102 may be or include some or all of the computer system 500 depicted in FIG. 5. In some aspects, the computing system 102 may belong to or be associated with an organization that provides cybersecurity services to clients. The computing system 102 may include feature extraction instructions 108 that, when executed by the processing device 104, cause the processing device 104 to perform functionality associated with executable parsing and feature extraction as described herein. In some aspects, the feature extraction instructions 108 may include or implement a parser that is configured to analyze symbols in natural language, programming languages, and/or data structures while conforming to the rules of a formal grammar. In some aspects, the parser may be implemented in a programming language (e.g., Rust®) that emphasizes performance, type safety, concurrency, and memory safety (i.e., all reference point to valid memory) and that does not use a garbage collector. For instance, the programming language may track an object lifetime of a reference at a compile time instead of using a garbage collector.

The computing system 102 may obtain an executable file 110 and store the executable file 110 in the memory 106. For instance, the computing system 102 may receive the executable file 110 from a source over a network 112 (e.g., the Internet). As used herein, the term “executable file” may refer to a program that, when executed by a processing device, causes a computer to perform indicated tasks according to encoded instructions. In some aspects, the executable file 110 is a binary file. In some aspects, the executable file 110 is a non-binary file. In some aspects, the executable file 110 may include an embedded runtime. The embedded runtime may include memory management functionality, thread scheduling and management, garbage collection (i.e., garbage collector functionality), concurrency support, system calls, and/or stack management. The embedded runtime may act as a bridge between the executable file 110 and an operating system. In some aspects, the executable file 110 may be a statically linked executable file. In some aspects, the executable file 110 may be a dynamically linked executable file.

The executable file 110 may be associated with a programming language. For instance, a compiler may compile source code in a high-level programming language into a low-level programming language (e.g., assembly language, object code, machine code, etc.) to generate the executable file 110. In some aspects, the programming language (e.g., a high-level programming language) may be a statically typed, compiled programming language with memory safety, garbage collection, structural typing, and concurrency. In an example, the programming language may be or include Go® (which may also be referred to as Golang). The executable file 110 may also be associated with a version of the programming language (referred to hereafter as “the programming language version 114”), that is, the executable file 110 may be compiled from source code that adheres to the programming language version 114 and/or the executable file 110 may run in a runtime environment associated with the programming language version 114. Additionally or alternatively, different versions of a programming language may be associated with different compilers, different linkers, different libraries, different debuggers, etc. In an example, the executable file 110 may be associated with a first version of a programming language, a second version of a programming language, or a third version of a programming language. In an example, the executable file 110 may be associated with a first version of Golang, a second version of Golang, or a third version of Golang.

In some aspects, the executable file 110 may or may not be associated with a cybersecurity threat, that is, the executable file 110 may or may not be malicious. In an example, if the executable file 110 is malicious, the executable file 110, when executed by a processing device, may cause or expose a computing system (e.g., the computing system 102, another computing system, etc.) to a cybersecurity threat. For example, the executable file 110 may cause or may be associated with a denial-of-service (DoS) attack, a distributed denial-of-service (DDoS attack), a ransomware attack, a structured query language (SQL) attack, a Trojan horse attack, a malware attack, etc. In an example, if the executable file 110 is non-malicious, the executable file 110, when executed by a processing device, may not cause or may not expose a computing system (e.g., the computing system 102, another computing system, etc.) to a cybersecurity threat.

In some aspects, the executable file 110 may include or be associated with a label 115. In some aspects, the label 115 may indicate whether the executable file 110 is malicious or non-malicious. In some aspects, the label 115 may indicate whether the executable file 110 is malicious, potentially malicious, or non-malicious. For instance, the executable file 110 may be labeled by a cybersecurity researcher, the executable file 110 may originate from a repository of executable files known to be malicious and/or non-malicious, etc. In some aspects, the computing system 102 labels the executable file 110 with the label 115 subsequent to obtaining the executable file 110.

The executable file 110 is associated with an operating system (OS) 116, that is, the executable file 110 may be configured to run on the OS 116. In an example, the OS 116 may be or include Windows®, Mac®, or Linux®. In an example, the executable file 110 may be a portable executable (PE) file that includes information for a loader to manage executable code, dynamic linked libraries (DLLs), object code, etc. In another example, the executable file 110 may be a Mach-O file. In yet another example, the executable file 110 may be an executable and linkable format (ELF) file.

The computing system 102 may identify the OS 116 and the programming language version 114 associated with the executable file 110 based on contents of the executable file 110. In an example, the computing system 102 may identify structure(s) 118 within the executable file 110 based on string(s) 120, indicator(s) 122, and/or offset(s) 124 within the executable file 110 in order to identify the OS 116 and the programming language version 114 of the executable file 110. As used herein, the term “structure” with respect to an executable file may refer to machine code instructions and data layouts optimized for execution by a processor. In an example, the structure(s) 118 may be or include a table that stores particular entry points and names of routines defined in a binary, a structure that references a version of a programming language, a structure that references an installation folder used during compilation of the executable file 110, a structure that references a source code file path, a structure that stores strings at runtime, a header to the executable file 110, a structure that stores type information and/or layout information pertaining to other structures, a structure that stores types of methods, a structure that records information about a layout of the executable file 110, and/or a structure that defines a range in memory dedicated to storing type information. As used herein, the term “structure” with respect to source code may refer to a user-defined type to store a collection of different fields into a single field. As used herein, a “string” may refer to a data type that represents a sequence of characters such as letters, numbers, symbols, or spaces. As used herein, the term “indicator” with respect to an executable file may refer to non-string data and/or instructions within an executable file that are associated with a particular purpose. As used herein, the term “offset” with respect to an executable file may refer to an adjustable value (e.g., a byte value, a bit value, etc.) or position (e.g., a byte position, a bit position, etc.) that is added to or subtracted from a starting point (e.g., a starting byte, a starting bit, etc.).

The computing system 102 may parse the executable file 110 based on the OS 116 and the programming language version 114 associated with the executable file 110. In some aspects, parsing may refer to analyzing symbols in natural language, programming languages, and/or data structures while conforming to the rules of a formal grammar. In some aspects, the computing system 102 may identify section(s) 126 of the executable file 110. For instance, the computing system 102 may identify the section(s) 126 of the executable file 110 based on the OS 116 and the programming language version 114 associated with the executable file 110. The section(s) 126 of the executable file 110 may be or include read-only section(s), write-only section(s), read and write section(s), and/or executable section(s). The computing system 102 may parse the executable file 110 based on the section(s) 126. For instance, the computing system 102 may mark portions of the section(s) 126. In some aspects, the computing system 102 may parse the executable file 110 via a first parser that is implemented in the feature extraction instructions 108, where the first parser has a first size (i.e., the first parser occupies a first amount of the memory 106) that is less than a second size of a second parser that is included in a toolchain associated with the programming language associated with the executable file 110.

The computing system 102 may extract a set of features 128 from the executable file 110 based on the parsing. In some aspects, the set of features 128 may include a count of symbols in the executable file 110, a count of function names in the executable file 110, a count of libraries referenced in the executable file 110, a count of modules referenced in the executable file 110, a count of sentinels in the executable file 110, a count of main strings in the executable file 110, a count of testing strings in the executable file 110, a count of debug strings in the executable file 110, a length of each of the main strings in the executable file 110, a length of each of the testing strings in the executable file 110, a length of each of the debug strings in the executable file 110, and/or an entropy of the executable file 110. A sentinel may refer to a special value used to mark the end of a sequence or indicate a specific condition, that is, a sentinel may be a flag value that signifies when to stop processing data. In some aspects, the computing system 102 may store the set of features 128 in a data structure (e.g., a vector, an array, a list, a table, a spreadsheet, etc.) in the memory 106.

In some aspects, extracting the set of features 128 from the executable file 110 may include copying features from the executable file 110. Additionally or alternatively, in some aspects, extracting the set of features 128 may include generating new features based on existing features within the executable file 110. In some aspects, the set of features may include the existing features, the new features, or a combination of existing and new features. In an example, the computing system 102 may calculate an entropy based on contents of the executable file 110. An entropy may refer to a randomness of characters, symbols, strings, etc. in the executable file 110. A relatively high entropy may be associated with the executable file 110 likely being malicious, whereas a relatively low entropy may be associated with the executable file 110 likely not being malicious. In an example, the computing system 102 may calculate a Shannon entropy based on the contents of the executable file 110. In some aspects, extracting the set of features 128 may include converting non-numerical data (e.g., textual data, categorical data, etc.) in the contents of the executable file 110 into numerical data (e.g., via label encoding). In some aspects, extracting the set of features 128 may include normalizing the set of features 128.

The computing system 102 may train an AI model 130 (e.g., a machine learning (ML) model) via a training process based on the set of features 128. In some aspects, the computing system 102 may additionally train the AI model 130 via the training process based on the label 115 of the executable file 110. The AI model 130 may include learned parameters 132 (e.g., weights) that are influenced by the training process. In some aspects, the AI model 130 may be or include a binary classifier model that is trained to classify executable files as malicious (i.e., as a cybersecurity threat) or non-malicious (i.e., as not a cybersecurity threat) based on contents of the executable files and the learned parameters 132 of the AI model 130. In some aspects, the AI model 130 may be or include a multiclassification model that is trained to classify executable files as malicious, potentially malicious, or non-malicious. In some aspects, the AI model 130 may be or include a logistic regression model, a naïve Bayes model, a k-nearest neighbor model, a decision tree, a random forest, a support vector machine, and/or a neural network such as an artificial neural network.

In an example, the computing system 102 may obtain executable files 134, where the executable files 134 include the executable file 110. In some aspects, the computing system 102 may obtain the executable files 134 from a repository of executable files that are known to be malicious and/or non-malicious. The executable files 134 may be similar to the executable file 110. For instance, the executable files 134 may be associated with OS(s) (not depicted in FIG. 1) and programming language version(s) (not depicted in FIG. 1). Some of the executable files 134 may be associated with the OS 116 and/or the programming language version 114, and some of the executable files 134 may be associated with OS(s) that are different from the OS 116 and/or programming language version(s) that are different from the programming language version 114. In some aspects, each of the executable files 134 is associated with a same programming language; however, versions of the programming language may differ (e.g., some of the executable files 134 may be associated with a first version of the programming language, some of the executable files 134 may be associated with a second version of the programming language, some of the executable files 134 may be associated with a third version of the programming language, etc.). Furthermore, contents of some or all of the executable files 134 may vary. For instance, structures, sections, strings, indicators, and/or offsets may vary between the executable files 134. The executable files 134 may include or be associated with labels (not depicted in FIG. 1). For example, some of the executable files 134 may be labeled as being malicious and some of the executable files 134 may be labeled as being non-malicious. In another example, some of the executable files 134 may be labeled as being malicious, some of the executable files 134 may be labeled as being potentially malicious, and some of the executable files 134 may be labeled as being non-malicious. In some aspects, the executable files 134 may be unlabeled when obtained by the computing system 102, and the computing system 102 may label the executable files 134 (e.g., based on input from an analyst) subsequent to obtain the executable files 134.

The computing system 102 may identify OSs associated with the executable files 134 and versions of a programming language associated with the executable files 134 in a manner similar to that described above with respect to the executable file 110. The computing system 102 may also parse the executable files 134 based on the OSs and the versions of the programming language in a manner similar to that described above with respect to the executable file 110. The computing system 102 may extract sets of features 136 from the (parsed) executable files 134 in a manner similar to that described above with respect to the executable file 110, where the sets of features 136 include the set of features 128. Each set of features in the sets of features 136 may correspond to a different executable file in the executable files 134. Features may vary between each of the sets of features 136. For instance, the set of features 128 may include a first entropy, and another set of features in the sets of features 136 may include a second entropy that may be different from the first entropy. The computing system 102 may train the AI model 130 via a training process based on the sets of features 136, where the learned parameters 132 (e.g., weights) are influenced by the sets of features 136 and the training process. The computing system 102 may additionally train the AI model 130 via the training process based on labels for the executable files 134. In some aspects, the computing system 102 may divide the executable files 134 into a training set and a validation set. The computing system 102 may train the AI model 130 based on the training set and the computing system 102 may test performance of the AI model 130 based on the validation set.

Subsequent to training the AI model 130, the computing system 102 may obtain a first executable file 138. In an example, the computing system 102 may obtain the first executable file 138 via the network 112 or from a storage device. The first executable file 138 (or a portion thereof) may be identical to one or more of the executable files 134 or the first executable file 138 (or a portion thereof) may be different from one or more of the executable files 134. For instance, the contents of the first executable file 138 may include structure(s), section(s), string(s), indicator(s), and/or offset(s), where some or all of the structure(s), the section(s), the string(s), the indicator(s), and/or the offset(s) may be different from the structure(s), the section(s), the string(s), the indicator(s), and/or the offset(s) of the executable files 134. The computing system 102 may identify an OS (not depicted in FIG. 1) associated with the first executable file 138 and a version of a programming language associated with the first executable file 138 in a manner similar to that described above with respect to the executable file 110. The computing system 102 may also parse the first executable file 138 based on the OSs and the version of the programming language associated with the first executable file 138 in a manner similar to that described above with respect to the executable file 110. The computing system 102 may extract a first set of features 140 from the (parsed) first executable file 138 in a manner similar to that described above with respect to the executable file 110.

The computing system 102 may provide, as input to the AI model 130, the first set of features 140. The AI model 130 may produce an output based on the first set of features 140 and the learned parameters 132 of the AI model 130. In some aspects, the AI model 130 may output a classification 142 of the first executable file 138 based on the first set of features 140 and the learned parameters 132. In an example, the classification 142 may indicate whether the first executable file 138 is malicious or non-malicious. In another example, the classification 142 may indicate whether the first executable file 138 is malicious, potentially malicious, or non-malicious. In some aspects, if the classification 142 indicates that the first executable file 138 is malicious, the computing system 102 may present an alert (e.g., on a display) to a user, where the alert indicates that the first executable file 138 is malicious. In some aspects, if the classification 142 indicates that the first executable file 138 is malicious, the computing system 102 may transmit an alert to a computing device (e.g., a responder computing device), where the alert indicates that the first executable file 138 is malicious. In some aspects, if the classification 142 indicates that the first executable file 138 is malicious, the computing system 102 may perform a remedial action (e.g., quarantining the first executable file 138, ceasing execution of the first executable file 138, etc.) with respect to the first executable file 138.

In some aspects, the system may include an endpoint 144 (e.g., a computing device). In an example, the endpoint 144 may be or include a desktop computing device, a laptop computing device, a tablet computing device, a gaming console, a smartphone, a server, a cloud server, etc. In some aspects, the endpoint 144 and the computing system 102 may belong to/be associated with a common organization. In some aspects, the computing system 102 may belong to/be associated with a first organization and the endpoint 144 may belong to/be associated with a second organization, where the first organization provides cybersecurity related services to the second organization. In some aspects, the endpoint 144 may be or include the computer system 500 depicted in FIG. 5 (or a portion thereof).

The endpoint 144 may include a processing device 146 (e.g., a CPU, a GPU, etc.) and memory 148. The endpoint 144 may include feature extraction instructions 150. The feature extraction instructions 150 may include the functionality of the feature extraction instructions 108, with the exception of functionality pertaining to training AI models. The computing system 102 may transmit, via the network 112, the AI model 130 to the endpoint 144. The endpoint 144 may receive, via the network 112, the AI model 130 from the computing system 102. The endpoint 144 may store the AI model 130 in the memory 148 (or in data storage).

In an example, the endpoint 144 may obtain the first executable file 138 from a source. For instance, the endpoint 144 may obtain the first executable file 138 from the Internet. The endpoint 144 may identify an OS (not depicted in FIG. 1) associated with the first executable file 138 and a version of a programming language associated with the first executable file 138 in a manner similar to that described above with respect to the executable file 110. The endpoint 144 may also parse the first executable file 138 based on the OSs and the version of the programming language associated with the first executable file 138 in a manner similar to that described above with respect to the executable file 110. The endpoint 144 may extract a first set of features 140 from the (parsed) first executable file 138 in a manner similar to that described above with respect to the executable file 110.

The endpoint 144 may provide, as input to the AI model 130, the first set of features 140. The AI model 130 may produce an output based on the first set of features 140 and the learned parameters 132 of the AI model 130. In some aspects, the AI model 130 may output the classification 142 of the first executable file 138 based on the first set of features 140 and the learned parameters 132 as described above. In some aspects, if the classification 142 indicates that the first executable file 138 is malicious, the endpoint 144 may present an alert (e.g., on a display) to a user, where the alert indicates that the first executable file 138 is malicious. In some aspects, if the classification 142 indicates that the first executable file 138 is malicious, the endpoint 144 may transmit an alert to a computing device (e.g., the computing system 102), where the alert indicates that the first executable file 138 is malicious. In some aspects, if the classification 142 indicates that the first executable file 138 is malicious, the endpoint 144 may perform a remedial action (e.g., quarantining the first executable file 138, ceasing execution of the first executable file 138, etc.) with respect to the first executable file 138.

Although the description above focuses on training an AI model to detect cybersecurity threats from an executable file, other possibilities are contemplated. It is to be understood that the concepts presented herein may be applicable to training an AI model to classify behavior of an executable file that is not related to cybersecurity. Furthermore, although the description above focuses on training a classification AI model, other possibilities are contemplated. In some aspects, the executable file 110 may not be labeled, and the computing system 102 may utilize the concepts presented herein (e.g., feature extraction) to train an AI model to group unlabeled executable files based on similarities of the unlabeled executable files.

Some AI models and/or ML models developed to detect cybersecurity threats may not perform well on certain types of executable files. For instance, some AI models and/or ML models may have suboptimal performance when executed on compiled Golang (which may also be referred to as Go®) executables due to particular characteristics of Golang. As such, the aforementioned AI models and/or ML models may not reliably detect a cybersecurity threat in a compiled Golang executable or the aforementioned AI models and/or ML models may issue false positive detections on clean executable files.

Various technologies are described herein pertaining to identifying a Golang compiled executable, parsing internal Golang structures, and extracting relevant features from the parsed internal Golang structures. With respect to identifying the Golang compiled executable, the present disclosure describes identifying a structure based on a combination of searching certain strings or key indicators at certain offsets within the Golang compiled executable and identifying correct section and segment names in the Golang compiled executable based on a type of the Golang compiled executable. Along with identifying key structures, the present disclosure also describes identifying a version of Golang used. With respect to parsing the internal Golang structures, the present disclosure describes parsing in three main forms based on a version of Golang used. The three main forms may include Windows®, Mac®, and Linux®. With respect to the feature extraction, the present disclosure describes extracting and/or computing features from the Golang compiled executable based on the parsed structures. The present disclosure further describes using the extracted features for training an ML model and/or using the trained ML model for inference.

In some aspects, the present disclosure describes a modular independent parser that includes multi-architecture capability of identifying and parsing Golang structures. The modular independent parser is independent (i.e., not coupled, not tightly coupled, etc.) from a parser provided with a Golang toolchain. In some aspects, the present disclosure describes a feature extractor which may extract features from a compiled Golang executable including string lengths, counts, entropy, and/or the presence of certain indicators which can be used for both training and inference. In some aspects, the steps of identifying the compiled Golang executable, parsing the compiled Golang executable, and extracting the features are performed by an application written in a programming language that emphasizes performance, type safety, and concurrency, such as Rust®, in order to provide faster parsing times.

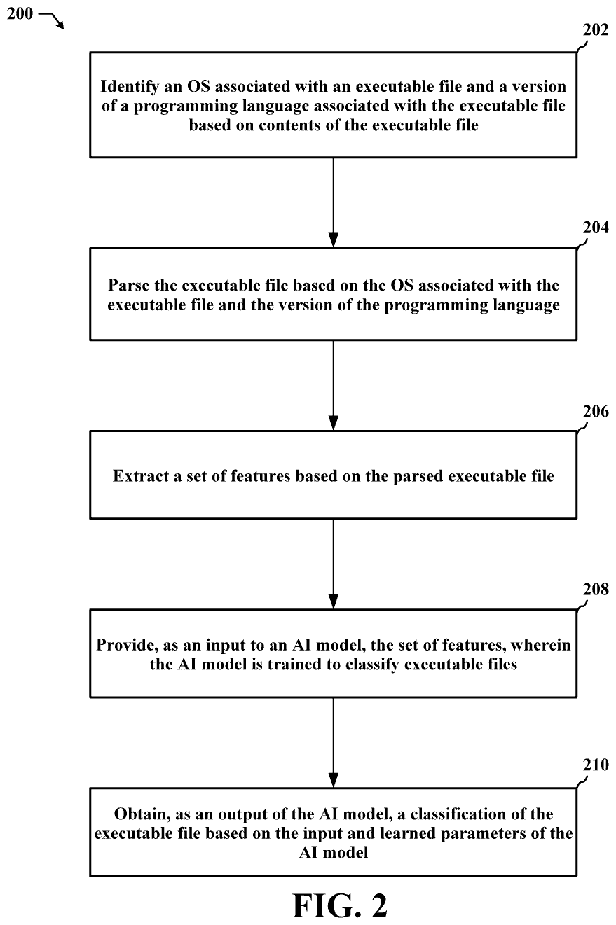

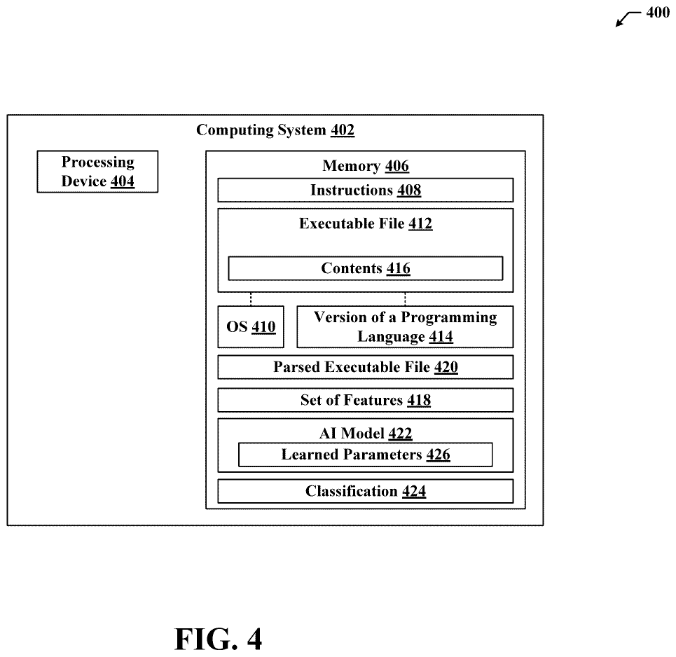

FIG. 2 is a flow diagram 200 of a method for executable parsing and feature extraction in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 104 (shown in FIG. 1), the processing device 404 (shown in FIG. 4), the processing device 502 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 202, a processing device identifies an OS associated with an executable file and a version of a programming language associated with the executable file based on contents of the executable file. In an example, the OS may be or include the OS 116, the executable file may be or include the executable file 110, and the version of the programming language may be or include the programming language version 114. In an example, the contents of the executable file may be or include the structure(s) 118, the section(s) 126, the string(s) 120, the indicator(s) 122, and/or the offset(s) 124. In another example, the OS may be or include the OS 410, the executable file may be or include the executable file 412, the version of the programming language may be or include the version of the programming language 414, and the contents of the executable file may be or include the contents 416.

At block 204, the processing device parses the executable file based on the OS associated with the executable file and the version of the programming language. In an example, parsing the executable file may be associated with the description of FIG. 1 above. In another example, parsing the executable file may be associated with the parsed executable file 420.

At block 206, the processing device extracts a set of features based on the parsed executable file. In an example, the set of features may be or include the set of features 128. In another example, the set of features may be or include the set of features 418.

At block 208, the processing device provides, as an input to an artificial intelligence (AI) model, the set of features, where the AI model is trained to classify executable files. In an example, the AI model may be or include the AI model 130. In another example, the AI model may be or include the AI model 422.

At block 210, the processing device obtains, as an output of the AI model, a classification of the executable file based on the input and learned parameters of the AI model. In an example, the classification may be or include the classification 142.

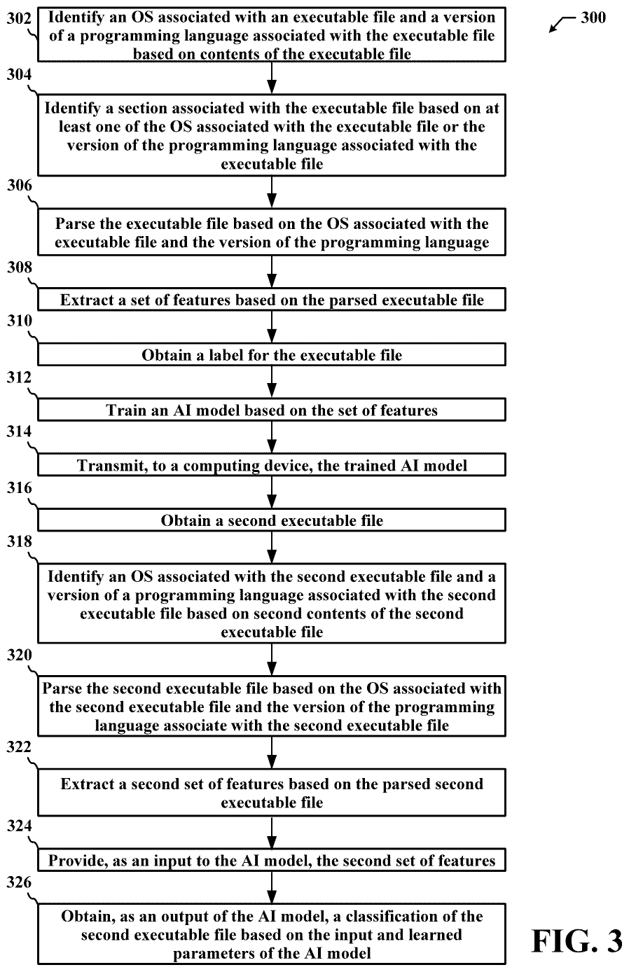

FIG. 3 is a flow diagram 300 of a method for executable parsing and feature extraction in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 104 (shown in FIG. 1), the processing device 404 (shown in FIG. 4), the processing device 502 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 302, the processing device identifies an OS associated with an executable file and a version of a programming language associated with the executable file based on contents of the executable file. In an example, the OS may be or include the OS 116, the executable file may be or include the executable file 110, and the version of the programming language may be or include the programming language version 114. In an example, the contents of the executable file may be or include the structure(s) 118, the section(s) 126, the string(s) 120, the indicator(s) 122, and/or the offset(s) 124. In another example, the OS may be or include the OS 410, the executable file may be or include the executable file 412, the version of the programming language may be or include the version of the programming language 414, and the contents of the executable file may be or include the contents 416.

In some aspects, at block 304, the processing device may identify a section associated with the executable file based on at least one of the OS associated with the executable file or the version of the programming language associated with the executable file. In some aspects, parsing the executable file may include parsing the executable file based on the section. In an example, the section may be or include the section(s) 126.

In some aspects, the section may include at least one of: a read-only section, a write-only section, a read and write section, or an executable section. In an example, the section(s) 126 may include at least one of: a read-only section, a write-only section, a read and write section, or an executable section.

At block 306, the processing device parses the executable file based on the OS associated with the executable file and the version of the programming language. In an example, parsing the executable file may be associated with the description of FIG. 1 above. In another example, parsing the executable file may be associated with the parsed executable file 420.

At block 308, the processing device extracts a set of features based on the parsed executable file. In an example, the set of features may be or include the set of features 128. In another example, the set of features may be or include the set of features 418.

In some aspects, extracting the set of features may include measuring an entropy of the executable file based on the contents of the executable file, where the set of features may include the entropy and at least one additional feature. For example, the set of features 128 may include an entropy of the executable file 110 and at least one additional feature.

In some aspects, the set of features may include at least one of: a count of symbols in the executable file, a count of function names in the executable file, a count of libraries referenced in the executable file, a count of modules referenced in the executable file, or a count of sentinels in the executable file. For example, the set of features 128 may include at least one of: a count of symbols in the executable file, a count of function names in the executable file, a count of libraries referenced in the executable file, a count of modules referenced in the executable file, or a count of sentinels in the executable file

In some aspects, the set of features may include at least one of: a count of main strings in the executable file, a count of testing strings in the executable file, a count of debug strings in the executable file, a length of each of the main strings in the executable file, a length of each of the testing strings in the executable file, or a length of each of the debug strings in the executable file. For example, the set of features 128 may include at least one of: a count of main strings in the executable file, a count of testing strings in the executable file, a count of debug strings in the executable file, a length of each of the main strings in the executable file, a length of each of the testing strings in the executable file, or a length of each of the debug strings in the executable file.

In some aspects, at block 310, the processing device may obtain a label for the executable file. For example, the label may be or include the label 115.

At block 312, the processing device trains an AI model based on the set of features. In an example, the AI model may be or include the AI model 130. In another example, the AI model may be or include the AI model 422.

In some aspects, training the AI model may include training the AI model additionally based on the label for the executable file. For example, training the AI model 130 may include training the AI model 130 additionally based on the label 115 for the executable file 110.

In some aspects, at block 314, the processing device may transmit, to a computing device, the trained AI model. For example, the computing device may be or include the endpoint 144.

In some aspects, at block 316, the processing device may obtain a second executable file. For example, the second executable file may be or include the first executable file 138.

In some aspects, at block 318, the processing device may identify an OS associated with the second executable file and a version of a programming language associated with the second executable file based on second contents of the second executable file. For example, the aforementioned aspect may correspond to the description of FIG. 1 above.

In some aspects, at block 320, the processing device may parse the second executable file based on the OS associated with the second executable file and the version of the programming language associated with the second executable file. For example, the aforementioned aspect may correspond to the description of FIG. 1 above.

In some aspects, at block 322, the processing device may extract a second set of features based on the parsed second executable file. For example, the second set of features may be or include the first set of features 140.

In some aspects, at block 324, the processing device may provide, as an input to the AI model, the second set of features. For example, the aforementioned aspect may correspond to the description of FIG. 1 above.

In some aspects, at block 326, the processing device may obtain, as an output of the AI model, a classification of the second executable file based on the input and learned parameters of the AI model. For example, the aforementioned aspect may correspond to the description of FIG. 1 above. In an example, the classification may be or include the classification 142.

In some aspects, the executable file may include garbage collector functionality. For example, the aforementioned aspect may correspond to the description of FIG. 1 above.

In some aspects, the executable file may include a statically linked executable file or a dynamically linked executable file. For example, the aforementioned aspect may correspond to the description of FIG. 1 above.

In some aspects, training the AI model based on the set of features comprises training the AI model to classify executable files as malicious or non-malicious. For example, the aforementioned aspect may correspond to the description of FIG. 1 above.

In some aspects, identifying the OS associated with the executable file and the version of the programming language associated with the executable file based on the contents of the executable file may include identifying a structure within the executable file based on at least one of a string, an indicator, or an offset within the executable file, where parsing the executable file may include parsing the executable file based on the structure. In an example, the structure may be or include the structure(s) 118, the string may be or include the string(s) 120, the indicator may be or include the indicator(s) 122, and the offset may be or include the offset(s) 124.

In some aspects, the programming language may be a compiled programming language with memory safety, garbage collection, and structural typing. For example, the aforementioned aspect may correspond to the description of FIG. 1 above.

In some aspects, parsing the executable file may include parsing the executable file via a first parser, where the first parser may have a first size that is less than a second size of a second parser that is included in a toolchain associated with the programming language. For example, the aforementioned aspect may correspond to the description of FIG. 1 above.

FIG. 4 is a block diagram 400 that illustrates an example of a computing system 402 for executable parsing and feature extraction in accordance with some aspects of the present disclosure. In some aspects, the computing system 402 may perform some or all of the functionality described herein. The computing system 402 includes a processing device 404 and memory 406. The memory 406 stores instructions 408 that are executed by the processing device 404. The instructions 408, when executed by the processing device 404, cause the processing device 404 to identify an OS 410 associated with an executable file 412 and a version of a programming language 414 associated with the executable file 412 based on contents 416 of the executable file 412. The instructions 408, when executed by the processing device 404, cause the processing device 404 to parse the executable file 412 based on the OS 410 associated with the executable file 412 and the version of the programming language 414. The instructions 408, when executed by the processing device 404, cause the processing device 404 to extract a set of features 418 based on the parsed executable file 420. The instructions 408, when executed by the processing device 404, cause the processing device 404 to provide, as an input to an AI model 422, the set of features 418, wherein the AI model 422 is trained to classify executable files. The instructions 408, when executed by the processing device 404, cause the processing device 404 to obtain, as an output of the AI model 422, a classification 424 of the executable file 412 based on the input and learned parameters 426 of the AI model 422.

FIG. 5 illustrates a diagrammatic representation of a machine in the example form of a computer system 500 within which a set of instructions, for causing the machine to perform any one or more of the methodologies discussed herein for executable parsing and feature extraction.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 500 may be representative of a server.

The computer system 500 includes a processing device 502, a main memory 504 (e.g., read-only memory (ROM), flash memory, dynamic random access memory (DRAM), a static memory 505 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., an acoustic signal generation device, such as a speaker). In some embodiments, the video display unit 510, the alphanumeric input device 512, and the cursor control device 514 may be combined into a single component or device (e.g., an LCD touch screen).

The processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute feature extraction instructions 525, for performing the operations and steps discussed herein. For example, the feature extraction instructions 525 may include instructions for identifying an operating system (OS) associated with an executable file and a version of a programming language associated with the executable file based on contents of the executable file. The feature extraction instructions 525 may include instructions for parsing the executable file based on the OS associated with the executable file and the version of the programming language. The feature extraction instructions 525 may include instructions for extracting a set of features based on the parsed executable file. The feature extraction instructions 525 may include instructions for providing, as an input to an artificial intelligence (AI) model, the set of features, wherein the AI model is trained to classify executable files. The feature extraction instructions 525 may include instructions for obtaining, as output of the AI model, a classification of the executable file based on the input and learned parameters of the AI model.

The data storage device 518 may include a machine-readable storage medium 528 that stores the feature extraction instructions 525 (e.g., software) embodying any one or more of the methodologies of functions described herein. The feature extraction instructions 525 may also reside, completely or at least partially, within the main memory 504 or within the processing device 502 during execution thereof by the computer system 500; the main memory 504 and the processing device 502 also constituting machine-readable storage media. The feature extraction instructions 525 may further be transmitted or received over a network 520 via the network interface device 508.

While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “identifying,” “determining,” “parsing,” “extracting,” “selecting,” “marking,” “indicating,” “training,” “generating,” “transmitting,” “receiving,” “obtaining,” “inputting,” “outputting,” “providing,” “measuring,” “computing,” “calculating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
identifying an operating system (OS) associated with an executable file and a version of a programming language associated with the executable file based on contents of the executable file;
parsing the executable file based on the OS associated with the executable file and the version of the programming language;
extracting, by a processing device, a set of features based on the parsed executable file;
providing, as an input to an artificial intelligence (AI) model, the set of features, wherein the AI model is trained to classify executable files; and
obtaining, as an output of the AI model, a classification of the executable file based on the input and learned parameters of the AI model.

2. The method of claim 1, wherein the executable file includes garbage collector functionality.

3. The method of claim 1, wherein the executable file comprises a statically linked executable file or a dynamically linked executable file.

4. The method of claim 1, further comprising:
identifying an OS associated with a second executable file and a version of a programming language associated with the second executable file based on second contents of the second executable file;
parsing the second executable file based on the OS associated with the second executable file and the version of the programming language associated with the second executable file;
extracting a second set of features based on the parsed second executable file; and
training the AI model based on the second set of features.

5. The method of claim 4, further comprising:
transmitting, to a computing device, the trained AI model.

6. The method of claim 4, further comprising:
obtaining a label for the second executable file, wherein the training the AI model comprises training the AI model additionally based on the label for the second executable file.

7. The method of claim 1, wherein the classification indicates that the executable file is malicious or non-malicious.

8. The method of claim 1, wherein the identifying the OS associated with the executable file and the version of the programming language associated with the executable file based on the contents of the executable file comprises:
identifying a structure within the executable file based on at least one of a string, an indicator, or an offset within the executable file, wherein the parsing the executable file comprises parsing the executable file based on the structure.

9. The method of claim 1, further comprising:
identifying a section associated with the executable file based on at least one of the OS associated with the executable file or the version of the programming language associated with the executable file, wherein the parsing the executable file comprises parsing the executable file based on the section.

10. The method of claim 9, wherein the section comprises at least one of:
a read-only section,
a write-only section,
a read and write section, or
an executable section.

11. The method of claim 1, wherein the extracting the set of features comprises measuring an entropy of the executable file based on the contents of the executable file, and wherein the set of features comprises the entropy and at least one additional feature.

12. The method of claim 1, wherein the set of features comprises at least one of:
a count of symbols in the executable file,
a count of function names in the executable file,
a count of libraries referenced in the executable file,
a count of modules referenced in the executable file, or
a count of sentinels in the executable file.

13. The method of claim 1, wherein the set of features comprises at least one of:
a count of main strings in the executable file,
a count of testing strings in the executable file,
a count of debug strings in the executable file,
a length of each of the main strings in the executable file,
a length of each of the testing strings in the executable file, or
a length of each of the debug strings in the executable file.

14. The method of claim 1, wherein the programming language is a compiled programming language with memory safety, garbage collection, and structural typing.

15. The method of claim 1, wherein the parsing the executable file comprises parsing the executable file via a first parser, wherein the first parser has a first size that is less than a second size of a second parser that is included in a toolchain associated with the programming language.

16. A system, comprising:
a processing device; and
a memory to store instructions that, when executed by the processing device, cause the processing device to:
identifying an operating system (OS) associated with an executable file and a version of a programming language associated with the executable file based on contents of the executable file;
parsing the executable file based on the OS associated with the executable file and the version of the programming language;
extracting a set of features based on the parsed executable file;
providing, as an input to an artificial intelligence (AI) model, the set of features, wherein the AI model is trained to classify executable files; and
obtaining, as an output of the AI model, a classification of the executable file based on the input and learned parameters of the AI model.

17. The system of claim 16, wherein to identify the OS associated with the executable file and the version of the programming language associated with the executable file based on the contents of the executable file, the instructions, when executed by the processing device, cause the processing device to:
identify a structure within the executable file based on at least one of a string, an indicator, or an offset within the executable file, wherein to parse the executable file, the instructions, when executed by the processing device, cause the processing device to parse the executable file based on the structure.

18. The system of claim 16, wherein to extract the set of features, the instructions, when executed by the processing device, cause the processing device to measure an entropy of the executable file based on the contents of the executable file, and wherein the set of features comprises the entropy and at least one additional feature.

19. A non-transitory computer readable medium, having instructions stored thereon which, when executed by a processing device, cause the processing device to:
identifying an operating system (OS) associated with an executable file and a version of a programming language associated with the executable file based on contents of the executable file;
parsing the executable file based on the OS associated with the executable file and the version of the programming language;
extracting, by the processing device, a set of features based on the parsed executable file;
providing, as an input to an artificial intelligence (AI) model, the set of features, wherein the AI model is trained to classify executable files; and
obtaining, as an output of the AI model, a classification of the executable file based on the input and learned parameters of the AI model.

20. The non-transitory computer readable medium of claim 19, wherein the programming language is a compiled programming language with memory safety, garbage collection, and structural typing.
